(19) United States
(12) Patent Application Publication
(10) Pub. No.: US 2026/0309221 A1
(43) Pub. Date: Oct. 8, 2026

(54) TRANSMISSION SHAFT MOUNTING STRUCTURE AND PARALLEL DRIVING DEVICE

(71) Applicant: Arctech Solar Holding Co., LTD, Jiangsu (CN)

(72) Inventors: Yongquan Mao, Jiangsu (CN); Zhengming Yu, Jiangsu (CN); Hua Tao, Jiangsu (CN)

(73) Assignee: Arctech Solar Holding Co., LTD, Jiangsu (CN)

(21) Appl. No.: 18/875,274

(22) PCT Filed: Jun. 21, 2023
(86) PCT No.: PCT/CN2023/101804

§ 371 Date: Dec. 16, 2024

(30) Foreign Application Priority Data
Mar. 13, 2023 (CN) 202320455699.5

(51) Int. Cl. F16H 57/021; F16H 1/16; F16H 1/18; F16H 57/029; F16H 57/039

(52) U.S. Cl. CPC F16H 57/021; F16H 1/16; F16H 1/18; F16H 57/029; F16H 57/039; F16H 2057/0213

(57) ABSTRACT

This application provides a transmission shaft mounting structure and a parallel driving device. The mounting structure includes a housing and a transmission shaft. The transmission shaft has one end inside a first chamber and is installed in a mounting hole through two bearings. A distance bushing is provided between the bearings. An oil seal is provided between the bushing and the transmission shaft. The parallel driving device includes the mounting structure and six transmission members. The housing also includes a second and a third chamber independently lubricated. The sixth transmission member is a sector worm gear shaft with a hollow light weight structure and is connected to the photovoltaic main shaft through a connecting part, and the shaft head of the connecting part has a polygon contour of arcs and lines. The mounting structure has good versatility and lightweight. The lightweight connecting part withstands high bending moments and torques.

### FIELD OF THE DISCLOSURE

The present application relates to the technical field of photovoltaic supports, and in particular to a transmission shaft mounting structure and a parallel driving device.

### BACKGROUND

In the field of driving devices of photovoltaic tracking supports, due to the large wind vibration and weak wind resistance of the photovoltaic tracking support driven by a single driving device, the application of multi-point synchronous driving photovoltaic tracking systems in the field of photovoltaic tracking supports is increasing. The multi-point parallel driving mode has parallel drive outputs at the main shaft and at the synchronous shaft, and has the advantages of convenient operation and maintenance in the north-south direction and less jamming, and is chosen by more and more businesses.

The multi-point parallel driving mode usually uses a parallel driving device. The parallel driving device is equipped with a transmission shaft. The transmission shaft usually needs to be configured with multiple bearings, and special bearing seats and mounting structures need to be provided for these bearings. Such configurations are subject to high weight, low adaptability and other shortcomings.

### SUMMARY OF THE INVENTION

In view of the above shortcomings in the prior arts, the purpose of the present application is to provide a transmission shaft mounting structure with light weight and good adaptability and a parallel driving device including the transmission shaft mounting structure.

In order to achieve the above objects, the present application provides the following technical solutions.

A transmission shaft mounting structure, comprising: a housing provided with a first chamber; a first transmission shaft, wherein a first end of the first transmission shaft is located inside the first chamber; a first bearing and a second bearing, wherein the first transmission shaft is rotatably mounted to the housing through the first bearing and the second bearing; a bushing, which is installed between the first bearing and the second bearing so that the first bearing and the second bearing are axially spaced apart in the housing.

In some embodiments, the first transmission shaft is provided with an oil seal sleeve, wherein the oil seal sleeve is located between the first bearing and the second bearing, and an inner wall of the oil seal sleeve is in sealing contact with the first transmission shaft, and the transmission shaft mounting structure further comprises an oil seal, and the oil seal abuts against an outer wall of the oil seal sleeve.

In some embodiments, a transmission shaft mounting hole is provided at a chamber wall of the first chamber, and the first transmission shaft passes through the transmission shaft mounting hole into the first chamber; and a second end of the first transmission shaft is located outside the first chamber, wherein the first end and the second end are both used to install transmission members.

In some embodiments, one end of the transmission shaft mounting hole at the side of the first chamber has a radially inwardly protruding step structure, and an outer ring of the second bearing abuts against the step structure, and two sides of the bushing abut against an outer ring of the first bearing and the outer ring of the second bearing respectively; and the transmission shaft mounting structure further comprises an adjustment plug, which is threadedly connected to the transmission shaft mounting hole and abuts against the outer ring of the first bearing at the side away from the first chamber.

The present application further provides a parallel driving device, comprising: a transmission shaft mounting structure described in any embodiments mentioned above; a first transmission member which is fixedly connected to the first end of the first transmission shaft; a second transmission member which is meshed with the first transmission member, wherein an axis of the first transmission member is perpendicular to an axis of the second transmission member; a third transmission member which is fixedly connected to the second end of the first transmission shaft; a fourth transmission member which is located on an upper side of the third transmission member and meshes with the third transmission member, wherein an axis of the fourth transmission member is parallel to an axis of the third transmission member; a fifth transmission member which is coaxially fixed with the fourth transmission member; a sixth transmission member which is located on an upper side of the fifth transmission member and meshes with the fifth transmission member, and an axis of the fifth transmission member is perpendicular to an axis of the sixth transmission member; wherein, the sixth transmission member is above the second transmission member, and the axis of the sixth transmission member and the axis of the second transmission member are parallel to each other; wherein the first transmission member and the second transmission member are located inside the first chamber.

In some embodiments, the housing is further provided with a second chamber and a third chamber; wherein the third transmission member and the fourth transmission member are located in the second chamber, and the second chamber is located on one side of the first chamber, and the fifth transmission member and the sixth transmission member are located in the third chamber, and the third chamber is located above the first chamber, and chamber walls of the first chamber, the second chamber and the third chamber are provided with a grease injection port respectively.

In some embodiments, the sixth transmission member is a sector worm gear shaft, and the sixth transmission member comprises: a main body which is in a shape of a round tube; a worm gear portion which is circumferentially provided on the outer periphery of the main body; a first end plate which is fixedly connected to a first end of the main body; a second end plate which is fixedly connected to a second end of the main body; wherein, the first end plate and the second end plate are both circumferentially provided with first mounting holes, and are both provided with an opening at a center position; and the fifth transmission member is a toroidal worm; and the toroidal worm is meshed with the worm gear portion in transmission.

In some embodiments, the opening comprises a plurality of petal-shaped openings distributed circumferentially, and the first mounting holes are arranged between the petal-shaped openings.

Some embodiments further comprise a connecting part, wherein, the connecting part comprises an end portion and a shaft head, wherein the end portion is detachably fixed to the sixth transmission member using the first mounting holes, and the cross-sectional outer contour of the shaft head is a polygon of arcs and lines, and the shaft head is used to engage a photovoltaic main shaft with a cross-sectional inner contour as a polygon of arcs and lines; and the shaft head comprises a first arc plate located below, a horizontal plate located above, two vertical plates located on two sides respectively, and two second arc plates located between the horizontal plate and the two vertical plates respectively; wherein the first arc plate, the horizontal plate and the vertical plate are provided with at least one second installation hole respectively; and the outer peripheries of the first arc plate and the two second arc plates are located on a same cylindrical surface, and the cylindrical surface is coaxial with the sixth transmission member.

In some embodiments, the end portion comprises a guiding protrusion which protrudes in a direction away from the shaft head, and the outer contour of the guiding protrusion matches the inner contour of the opening.

In some embodiments, both the first transmission member and the second transmission member are helical gears.

Each embodiment of the present application has at least one of the following technical effects:
1. By arranging the two bearings directly in the same transmission shaft mounting hole of the housing, dedicated bearing seats can be omitted, reducing the overall weight of the transmission shaft mounting structure.
2. The spaced configuration of the two bearings is achieved through the bushing, which makes the configuration of the bearings more flexible. For example, bearings with different axial sizes can be selected while the length of the bushing is adjusted.
3. By integrating the oil seal onto the bushing, the independent lubrication of the chambers on both sides of the oil seal is ensured, and the sealing structure is simplified.
4. By arranging two spaced bearings in a central position of the transmission shaft, and installing transmission members at both ends of the transmission shaft, the number of bearings is reduced and the mounting structure of the transmission shaft is more compact, thereby reducing the weight of the housing and reducing the total weight of the structure.
5. The transmission shaft together with two bearings and all accessories can be installed from the outside of the first chamber, simplifying the installation process.
6. The weight of the sixth transmission member is reduced through the hollow structure of the sixth transmission member, the petal-shaped openings between the first mounting holes, and the groove on the inner surface of the worm gear portion.
7. Through the contour configuration of the connecting part as a polygon of arcs and lines, the connecting part can withstand high bending moment and torque, and the number of mounting holes is reduced, achieving a lightweight configuration.
8. By configuring the first transmission member and the second transmission member as helical gears, higher torque can be transmitted with the same weight, further reducing the weight of the parallel driving device.

### BRIEF DESCRIPTION OF THE DRAWINGS

In the following description, preferred embodiments will be described in a clear and understandable manner with reference to the accompanying drawings, and the above-mentioned characteristics, technical features, advantages and implementation methods of the present application will be further described.

FIG. 1 is a perspective view of a parallel driving device according to an embodiment;

FIG. 2 is a cross-sectional view of the embodiment in FIG. 1 along the plane where the first transmission shaft 201 and the second transmission shaft 202 are located;

FIG. 3 is an enlarged view of the part A in FIG. 2;

FIG. 4 is a cross-sectional view of the housing 100 of one embodiment;

FIG. 5 is a perspective view of the driving device 300 and the transmission mechanism 200;

FIG. 6 is a perspective view of the sixth transmission member 260;

FIG. 7 is a cross-sectional view of the sixth transmission member 260;

FIG. 8 is a perspective view of the connecting part 270;

FIG. 9 is a cross-sectional view of the connecting part 270;

FIG. 10 is an enlarged view of the part B in FIG. 4.

### EXPLANATION OF REFERENCE NUMBERS

100. Housing, 110. First chamber, 120. Second chamber, 130. Third chamber, 140. Transmission shaft mounting hole, 141. Step structure, 200. Transmission mechanism, 201. First transmission shaft, 202. Second transmission shaft, 203. Third transmission shaft, 210. First transmission member, 220. Second transmission member, 230. Third transmission member, 240. Fourth transmission member, 250. Fifth transmission member, 260. Sixth transmission member, 261. Main body, 262. Worm gear portion, 263. First end plate, 264. Second end plate, 265. First mounting hole, 266. Petal-shaped opening, 267. Groove, 270. Connecting part, 271. End portion, 272. First arc plate, 273. Horizontal plate, 274. Vertical plate, 275. Second arc plate, 277. Third mounting hole, 278. Second mounting hole, 279. Guiding protrusion, 281. First bearing, 282. Second bearing, 283. Bushing, 284. Oil seal, 285. Oil seal sleeve, 286. Nut, 287. Adjustment plug, 300. Driving device.

### DESCRIPTION OF THE ILLUSTRATED EMBODIMENTS

In order to more clearly illustrate the embodiments of the present application or the technical solutions in the prior arts, the specific embodiments of the present application will be described below with reference to the accompanying drawings. Obviously, the accompanying drawings in the following description are only some embodiments of the present application, and for those of ordinary skill in the art, other drawings can also be obtained from these drawings without creative efforts, to obtain other embodiments.

In order to keep the drawings concise, only the parts related to the application are schematically shown in each figure, and they do not represent the actual structure of the products. In addition, in order to make the drawings concise and easy to understand, in some figures, only one of the components having the same structure or function is schematically shown, or only one of them is labelled. As used herein, “one” not only means “only one”, but also “more than one”.

It should also be further understood that, as used in this specification and the claims, the term “and/or” refers to and including any and all possible combinations of one or more of the associated listed items.

In this description, it should be noted that, unless otherwise expressly specified and limited, the terms “installed”, “connected” and “connecting” should be understood in a broad sense. For example, it may be a fixed connection or a detachable connection, or it can be connected into a whole piece; or it can be a mechanical connection or an electrical connection; or it can be directly connected or indirectly connected through an intermediate medium, and it can be internal communication between two components. For those of ordinary skill in the art, the specific meanings of the above terms in the present application can be understood in specific situations.

In addition, in the description of the present application, the terms “first”, “second” and the like are only used to distinguish the features, and should not be understood as indicating or implying relative importance.

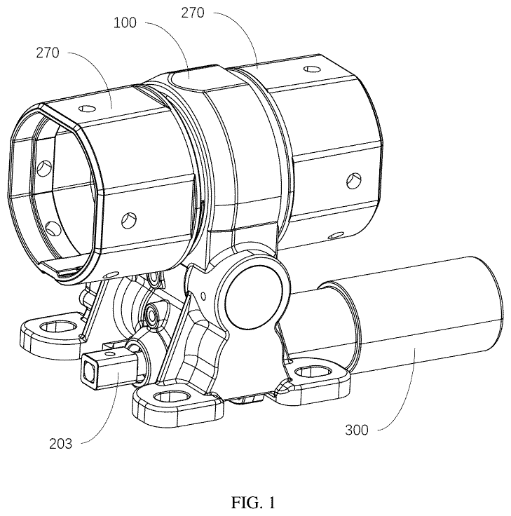

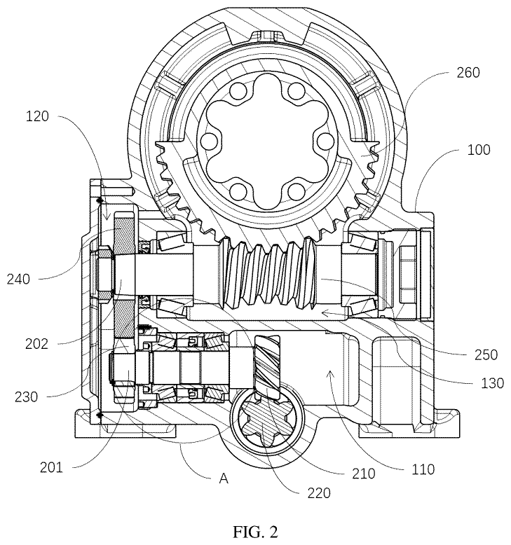

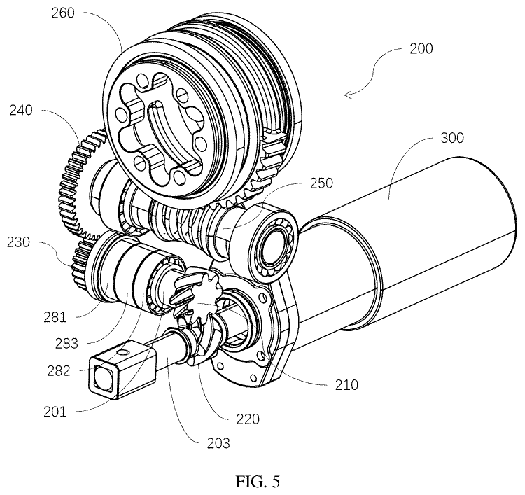

Embodiment 1. This embodiment is a transmission shaft mounting structure that can be used in the parallel driving device as shown in FIG. 1. The parallel driving device is used in a multi-point synchronously driven photovoltaic tracking support, so as to synchronously drive the photovoltaic main shaft and the synchronous shaft at multiple points through a same driving device 300. As shown in FIG. 2, this embodiment includes a housing 100 and a first transmission shaft 201. Referring to FIG. 5, the first transmission shaft 201 is an intermediate transmission shaft of the transmission mechanism 200 of the parallel driving device. For the specific arrangement of the transmission mechanism 200, please refer to the parallel driving device embodiments of this application. However, the transmission shaft mounting structure of this embodiment can also be used for other driving devices with similar arrangements.

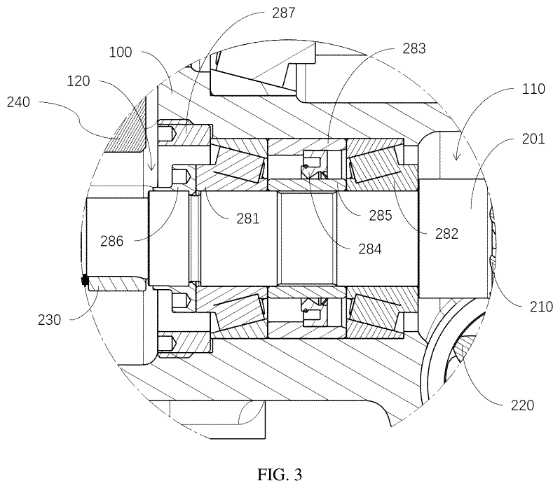

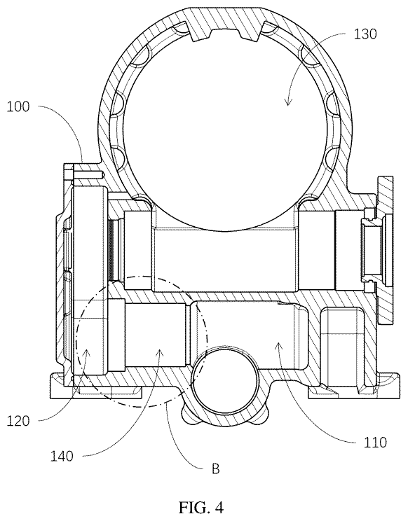

As shown in FIG. 2 and FIG. 4, the housing 100 has a first chamber 110; and the first transmission shaft 201 is at least partially located inside the first chamber 110. The first end of the first transmission shaft 201, i.e., the right end shown in FIG. 2, is located inside the first chamber 110. As shown in the enlarged view in FIG. 3, the mounting structure of this embodiment also includes a first bearing 281, a second bearing 282 and a bushing 283. The first transmission shaft 201 is rotatably installed on the housing 100 through the first bearing 281 and the second bearing 282. The bearings can specifically be installed on the chamber wall of the housing 100, or on other structural components in the housing 100 that have the function of a bearing seat. The bushing 283 is installed between the first bearing 281 and the second bearing 282 so that the first bearing 281 and the second bearing 282 are axially spaced on the mounting structure of the housing 100.

In the prior arts, separate mounting structures are usually provided for the two bearings, such as two stepped shaft holes arranged oppositely with an axial distance, and the two bearings are respectively fixed into the two stepped shaft holes from two directions. In addition, some existing technologies provide an integrated bearing seat for two bearings, and two stepped shaft holes are arranged on the bearing seat. After the two bearings are installed axially on the bearing seat, the assembly is then installed into a stepped shaft hole from one direction. This avoids the need to install the bearings from both sides, but the structure is more complex and the configuration increases the overall weight of the mounting structure. This application uses the bushing 283 to set two bearings apart, and arranges the two bearings and the bushing 283 directly on the mounting structure of the housing 100. This not only achieves a one-way installation process, but also uses a bushing with a much lighter weight. The bushing 283 replaces the bearing seat, reducing the overall weight of the mounting structure.

The mounting structure of this application also achieves additional technical effects. As shown in FIG. 2, both bearings can be installed from one side of the mounting structure of the housing 100, such as the mounting hole, and bearings with different axial sizes can be selected by simply replacing the bushings 283 with those having matching sizes at the same time. There is no need to change the mounting structure of the housing 100. This is very advantageous when the parallel driving device uses transmission mechanisms 200 with different configurations. Different first bearings 281 and second bearings 282 can be selected according to the load requirements and size configuration of the first transmission shaft 201, and the bushing 283 has a simple structure. Replacement costs are low. The first bearing 281 and the second bearing 282 can use common rolling bearings, but cheaper and lighter sliding bearings can also be used. Since the axial dimensions of the roller bearings and sliding bearings shown in FIG. 2 are directly related to their load-bearing capacity and rotational performance, the mounting structure of the present application can make the selection of the bearings more flexible.

Embodiment 2. On the basis of the embodiment 1, as shown in FIG. 3 and FIG. 4, a transmission shaft mounting hole 140 is provided on a chamber wall of the first chamber 110 of this embodiment, and the first transmission shaft 201 passes through the transmission shaft mounting hole 140 into the first chamber 110. The second end of the first transmission shaft 201 is located outside the first chamber 110. Both the first end and the second end of the first transmission shaft 201 are used to install transmission members. And the radial size of the transmission member mounted at the first end is smaller than the diameter of the transmission shaft mounting hole 140, thereby ensuring that the first transmission shaft 201 and its mounted structure can be installed from the outside of the first chamber 110. Moreover, when both ends of the first transmission shaft 201 are used to install transmission members, both ends of the first transmission shaft 201 are cantilever structures, forming a compact structure, and there is no need to install more bearings on the housing 100. Thereby the number of bearings is reduced, compared with the traditional structure in which bearings are provided at both ends of the first transmission shaft 201, and the structure of the housing 100 is also simplified. At the same time, the first bearing 281 and the second bearing 282 are spaced apart by the bushing 283 to ensure that the bending deflection of the first transmission shaft 201 is within specifications.

As shown in FIG. 3, the first transmission shaft 201 of this embodiment is also sleeved with an oil seal sleeve 285. The oil seal sleeve 285 is located between the first bearing 281 and the second bearing 282, and the oil seal sleeve 285 is sleeved onto the first transmission shaft 201. Its inner wall is in sealing contact with the first transmission shaft 201. The transmission shaft mounting structure of this embodiment also includes an oil seal 284. The oil seal 284 is installed in a step hole of the bushing 283, with the outside abutting against the inner wall of the bushing 283 and the inside abutting against the outer wall of the oil seal sleeve 285. The oil seal 284 can be an ordinary sealing ring, or a Variseal with better sliding sealing performance as shown in FIG. 3. The oil seal sleeve 285 is made of oil-resistant and wear-resistant polymer materials, which can improve the sealing performance between the oil seal 284 and the first transmission shaft 201 and reduce the wear of the oil seal 284. Since the transmission mechanism 200 is usually lubricated with grease, a sealing structure can be formed between the bushing 283 and the inner wall of the transmission shaft mounting hole 140 through clearance fit, or a simple structure comprising a sealing groove and a sealing ring can be provided between the bushing 283 and the transmission shaft mounting hole 140 as needed. The sealing groove and sealing ring prevent external dust and moisture from penetrating into the first chamber 110 when the second end of the first transmission shaft 201 is in an open structure.

The mounting structure of this embodiment allows the first transmission shaft 201 together with the transmission member mounted onto the first end, the first bearing 281, the second bearing 282, the bushing 283, the oil seal 284 and other components all to be installed from the outside of the first chamber 110. It makes the installation and the subsequent maintenance simple and convenient, and these parts can also be disassembled and replaced more simply.

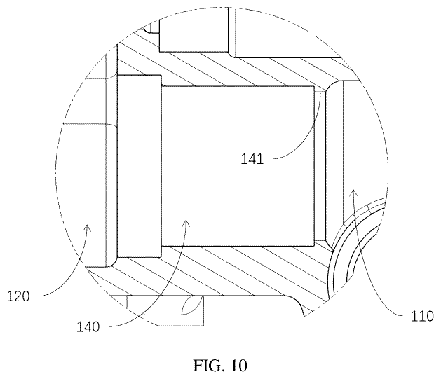

A preferred specific mounting structure and installation steps of this embodiment are described below. As shown in FIG. 4 and FIG. 10, the end of the transmission shaft mounting hole 140 at the side of the first chamber 110 has a radially inwardly protruding step structure 141. As shown in FIG. 3, the outer ring of the second bearing 282 is in contact with the step structure 141, and the bushing 283 is in contact between the outer ring of the first bearing 281 and the outer ring of the second bearing 282. The transmission shaft mounting structure also includes a nut 286 and an adjustment plug 287. The adjustment plug 287 is threadedly connected to the transmission shaft mounting hole 140 and abuts against the side of the outer ring of the first bearing 281 away from the first chamber 110, i.e., the left side in FIG. 3. Thereby, the outer ring of the first bearing 281, the bushing 283, the outer ring of the second bearing 282 and the step structure 141 of the transmission shaft mounting hole 140 are pressed against each other in sequence. When a first bearing 281 and a second bearing 282 with different axial sizes are used, in addition to adjusting the axial size of the bushing 283, the threaded range of the adjustment plug 287 can also be used for supplementary adjustment. When the sizes of the two bearings don't change much, then the bushing 283 may not be replaced, because the threaded range of the adjustment plug 287 alone can be used to achieve the adjustment. The nut 286 is threadedly connected to the first transmission shaft 201 and axially presses the inner ring of the first bearing 281, while the inner ring of the second bearing 282 presses against the shoulder of the first transmission shaft 201 on the right side in FIG. 3. The above-mentioned specific mounting structure is only a preferred embodiment, and those skilled in the art may also choose to set up other installation methods according to the specific structures of the first transmission shaft 201 and the transmission shaft mounting hole 140.

Embodiment 3. As shown in FIG. 1, this embodiment is a parallel driving device, which includes the transmission shaft mounting structure of any of the foregoing embodiments. This embodiment can be further divided functionally into three modules: the housing 100, the transmission mechanism 200 and the driving device 300. As shown in FIG. 5, in addition to the first transmission shaft 201, the transmission mechanism 200 of this embodiment also includes a second transmission member 220, a first transmission member 210, a third transmission member 230, a fourth transmission member 240, a fifth transmission member 250 and a sixth transmission member 260, which are drivingly connected in sequence and constitute the driving chain of the parallel driving device. A photovoltaic main shaft is usually arranged horizontally, and the axes of all transmission members in this embodiment are also arranged horizontally.

As shown in FIG. 5, the first transmission member 210 is fixedly connected to the first end of the first transmission shaft 201, and the second transmission member 220 is fixedly connected to the output shaft of the driving device 300, i.e., the third transmission shaft 203. And the second transmission member 220 is vertically meshed with the first transmission member 210. The third transmission member 230 is fixedly connected to the second end of the first transmission shaft 201; and the fourth transmission member 240 is located on the upper side of the third transmission member 230 and is meshed with the third transmission member 230, and its axis is arranged parallel to the axis of the third transmission member 230. The fifth transmission member 250 and the fourth transmission member 240 are coaxially connected through the second transmission shaft 202 (not labeled in FIG. 5, please refer to FIG. 2). The sixth transmission member 260 is located on the upper side of the fifth transmission member 250 and is meshed with the fifth transmission member 250, and its axis is perpendicular to the axis of the fifth transmission member 250.

Wherein, the sixth transmission member 260 is above the second transmission member 220 and the axes of the two are parallel to each other. As shown in FIG. 2 and FIG. 5, the first transmission member 210 and the second transmission member 220 are both located inside the first chamber 110. The second transmission member 220 is located on the lower side of the first transmission member 210 and is meshed with the first transmission member 210 in a vertical direction. The first transmission member 210 and the second transmission member 220 of this embodiment adopt helical gears, and compared with bevel gears, the weight is smaller under the premise of transmitting the same torque.

As shown in FIG. 5, in terms of the function of this embodiment, the second transmission member 220 and the sixth transmission member 260 are parallel to each other in the axial direction through the arrangement and cooperation of a plurality of transmission members, so that the parallel driving of the two can be achieved. In practical applications, the sixth transmission member 260 is above the second transmission member 220, and the sixth transmission member 260 is used to connect to the photovoltaic main shaft and drive the photovoltaic main shaft to rotate, and further to drive the photovoltaic panels to rotate with the photovoltaic main shaft. In addition, the second transmission member 220 and the third transmission shaft 203 also have the function of synchronous driving, wherein the third transmission shaft 203 is used as another parallel output under the sixth transmission member 260, and can drive photovoltaic main shafts at other positions through coupling components, constituting a multi-point synchronous drive photovoltaic tracking system. Moreover, the sixth transmission member 260 is arranged directly above the second transmission member 220, so that the parallel driving device constituted by the two transmission members is more stable, and it is convenient to install in the photovoltaic tracking support system.

The parallel driving device also includes a driving device 300 as a power source. The driving device 300 is usually a servo motor or a reduction motor including a reduction mechanism. The output shaft of the driving device 300 in this embodiment is the third transmission shaft 203, which is directly connected with the second transmission member 220. But the output shaft can also be directly connected to any one of the first transmission member 210, the third transmission member 230 to the fifth transmission member 250. A parallel driving device that does not include a driving device 300 can obtain power from other parallel driving devices that has a third transmission shaft 203 connected to a driving device 300.

In terms of the overall structure, each transmission member is arranged inside the housing 100, so that the housing 100 has a gear box structure. The first transmission member 210, the second transmission member 220 and the third transmission member 230 are relatively arranged in the lower layer of the housing 100, while the fourth transmission member 240, the fifth transmission member 250, and the sixth transmission member 260 are relatively arranged in the upper layer of the housing 100. In this configuration, the housing 100 is arranged into a two-layer structure, which makes the housing 100 more rigid, and effectively reduces its structural deformation during operation, and reduces the weight and cost of the housing 100.

More preferably, as shown in FIG. 2 and FIG. 4, the housing 100 further includes a second chamber 120 and a third chamber 130. The first transmission member 210 and the second transmission member 220 are located in the first chamber 110 in the housing 100. The first chamber 110 constitutes the first meshing chamber. The third transmission member 230 and the fourth transmission member 240 are located in the second chamber. The fifth transmission member 250 and the sixth transmission member 260 are located in the third chamber 130 so that the third chamber 130 forms a third meshing chamber. And each meshing chamber of the housing 100 is respectively provided with at least one grease injection port, thereby constituting three independent grease lubricated chambers in the housing 100: the vertical meshing chamber of the first transmission member 210 and the second transmission member 220, the parallel meshing chamber of the third transmission member 230 and the fourth transmission member 240, and the vertical meshing chamber of the fifth transmission member 250 and the sixth transmission member 260. The three grease lubricated chambers can be isolated by oil seals, saving the amount of grease and also ensuring the overall lubrication and sealing effect, and reducing maintenance costs.

In order to make the structure of the entire device more compact and concise, the second chamber 120 is located on one side of the first chamber 110 and the third chamber 130. The fifth transmission member 250, the sixth transmission member 260, the first transmission member 210, and the second transmission member 220 are all located on the same side of the plane where the second chamber 120, the fourth transmission member 240 and the third transmission member 230 are located. Wherein, regarding the arrangement of the driving device 300, there are various arrangements.

One arrangement of the driving device 300 is as follows: as shown in FIG. 5, the second transmission member 220 is located on the lower side of the first transmission member 210, and the driving device 300 is connected to the second transmission member 220 through the third transmission shaft 203. The driving device 300 is arranged on one side of the first transmission member 210 along a direction parallel to the axial direction of the sixth transmission member 260. This configuration has better compactness in the overall structure. When a row of photovoltaic supports is provided with n parallel driving devices, about 1/n of the power of the driving device 300 is transmitted to the sixth transmission member 260 through the first transmission member 210 and other components, and the remaining power is about (n−1)/n. The remaining power is distributed in parallel to the parallel driving devices at other positions through the third transmission shaft 203 to synchronously drive the photovoltaic supports. Since the staggered helical gear pair of the first transmission member 210 and the second transmission member 220 has a center distance in the height direction, the center distance between the second transmission member 220 and the sixth transmission member 260 can be effectively enlarged, thereby adapting to the center distance requirements in the installation of the photovoltaic support system.

Another arrangement is: there is no height difference between the second transmission member 220 and the first transmission member 210, and the driving device 300 is drivingly connected to either end of the third transmission shaft 203. This configuration can save the vertical assembly space of the parallel driving device in the photovoltaic tracking support. This configuration is suitable for occasions where the center distance between the second transmission member 220 and the sixth transmission member 260 is easy to meet the requirements. Both the first transmission member 210 and the second transmission member 220 are bevel gears, and they are meshed and connected at 90° to form a bevel gear pair. More preferably, the gear transmission ratio of the first transmission member 210 and the second transmission member 220 is 1:1. In practical applications, the first transmission member 210 and the second transmission member 220 may use bevel gears of the same specification, which effectively reduces the types of gears and reduces the cost. In this embodiment, the driving device 300 is disposed at one end of the second transmission member 220 in a direction parallel to the axial direction of the sixth transmission member 260, so that the overall structure can still be kept compact. The power distribution method of the driving device 300 can be the same as the previous arrangement.

As mentioned above, the arrangement of the driving device 300 is not limited to the above embodiments. For example, the driving device 300 can also be directly drivingly connected to the fourth transmission member 240 or directly drivingly connected to the fifth transmission member 250, which can be adaptively adjusted according to requirements. Of course, the number of the driving device 300 is not limited to one, and they can be combined in a variety of implementations according to requirements, thereby making the structural arrangement more flexible and convenient.

As shown in FIG. 5, both the third transmission member 230 and the fourth transmission member 240 are configured as cylindrical gears, and the two transmission members are axially parallelly meshed and connected to constitute a pair of cylindrical gears parallel to each other. The first transmission member 210 and the third transmission member 230 are respectively connected and arranged at two ends of the first transmission shaft 201 through shaft key structures. The number of teeth of the third transmission member 230 is smaller than the number of teeth of the fourth transmission member 240, so that the transmission ratio or torque of the driving device 300 is amplified through the reduction gear pair constituted by the third transmission member 230 and the fourth transmission member 240.

The fifth transmission member 250 is a toroidal worm, which can be produced separately and installed onto the second transmission shaft 202. Or the fifth transmission member 250 can also be integrated with the second transmission shaft 202. When a toroidal worm is used, the transmission ratio of the worm gear pair is large, and more worm teeth are engaged at the same time than a cylindrical worm, and the bearing capacity is higher. At the same time, the self-locking performance of the toroidal worm is excellent, and the locking effect is reliable. The sixth transmission member 260 is a sector worm gear shaft. The toroidal worm meshes with the worm gear portion 262 on the sector worm gear shaft to constitute a toroidal worm gear pair with a large reduction ratio. After the torque amplification, the main shaft of the photovoltaic system which is connected to the sixth transmission member 260 is driven to rotate. And a self-locking can be achieved after the angle adjustment is completed.

The second transmission shaft 202 is rotatably installed in the housing 100 through bearings provided on both sides of the third chamber 130. The third transmission shaft 203 on which the second transmission member 220 is arranged is configured in a lower position in the first chamber 110 through bearings. The bearings of the third transmission shaft 203 can be replaced in conjunction with the bearings of the second transmission shaft 202. For example, the bearings of the third transmission shaft 203 are replaced with smaller-sized bearings, and the bearings of the second transmission shaft 202 are replaced with larger-sized bearings at the same time. Under the condition that the center distance between the second transmission member 220 and the sixth transmission member 260 remains unchanged, the bearings on both sides of the fifth transmission member 250 are changed into bearings with higher strength, which can increase the holding moment of the fifth transmission member 250.

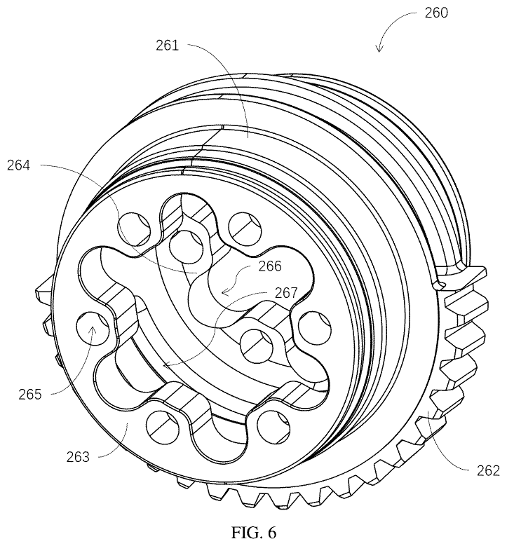

Embodiment 4. On the basis of the embodiment 3, this embodiment illustrates a preferred lightweight configuration of the sixth transmission member 260. As shown in FIG. 6, the sixth transmission member 260 is a sector worm gear shaft, which integrates the function of a rotating shaft and the function of a transmission member. The sixth transmission member 260 specifically includes a main body 261, a worm gear portion 262, a first end plate 263 and a second end plate 264. The main body 261 is substantially in a shape of a round tube, and part of the lengths at both ends of the main body 261 constitute axle journals to be rotatably configured in the third chamber 130 of the housing 100. The worm gear portion 262 is circumferentially provided on the outer periphery of the main body 261 and is preferably a sector worm gear portion to reduce weight, and is configured as a toroidal worm gear structure to match with the fifth transmission member 250. Specifically, the worm gear portion 262 can be a part produced separately and welded onto the main body 261, or can be further processed after integral casting together with the main body 261.

The main body 261 is rotatably configured on the housing 100 and is drivingly connected to the photovoltaic main shaft. The torque transmitted by the worm gear portion 262 can drive the photovoltaic main shaft to rotate. The tubular structure of the main body 261 gives the sixth transmission member 260 a hollow structure, and the hollow structure does not need to be used for transmission or rotational connection. That is to say, the hollow structure is different from a shaft hole in the traditional sense, so there are no size and surface finish requirements. Materials are saved and production costs are reduced. The axle journal formed by the outer wall of the main body 261 has a larger diameter and a higher load-bearing capacity than a traditional shaft, so that the wall thickness of the main body 261 can be reduced, further achieving a lightweight configuration.

In order to facilitate the connection of the photovoltaic main shaft, the first end plate 263 and the second end plate 264 are fixedly connected to the first end and the second end of the main body 261 respectively. Wherein, both the first end plate 263 and the second end plate 264 are circumferentially provided with first installation holes 265, and both are provided with an opening at the center, thereby maintaining the lightweight structure of the sixth transmission member 260.

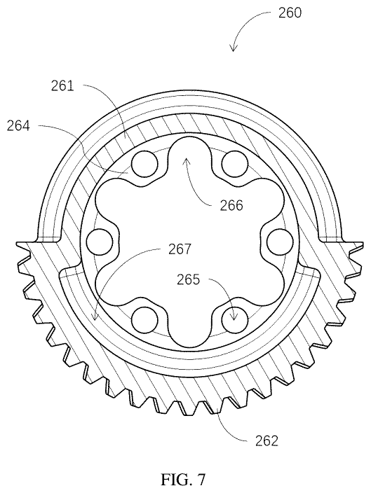

More preferably, as shown in FIG. 7, the openings on the first end plate 263 and the second end plate 264 include circumferentially distributed petal-shaped openings 266. The bottom of the petal-shaped openings 266, that is, the position close to the main body 261 is arc-shaped. For example, the present embodiment shown in FIG. 7 is provided with six petal-shaped openings 266 evenly distributed circumferentially, so that the petal-shaped openings as a whole have a six-petal flower shape. Of course, the opening can also be set in a plum blossom shape including five petal-shaped openings 266. The six first mounting holes 265 are arranged between the six petal-shaped openings 266. The bottom arc structure of the petal-shaped opening 266 can ensure that the protruding structure where the first mounting hole 265 is located has sufficient strength. It can also be seen from FIG. 6 and FIG. 7 that the main body 261 is provided with a groove 267 corresponding to the inner surface of the worm gear portion 262, which makes the sixth transmission member 260 lighter and it has a uniform thickness in the overall structure, which is beneficial to avoid casting defects.

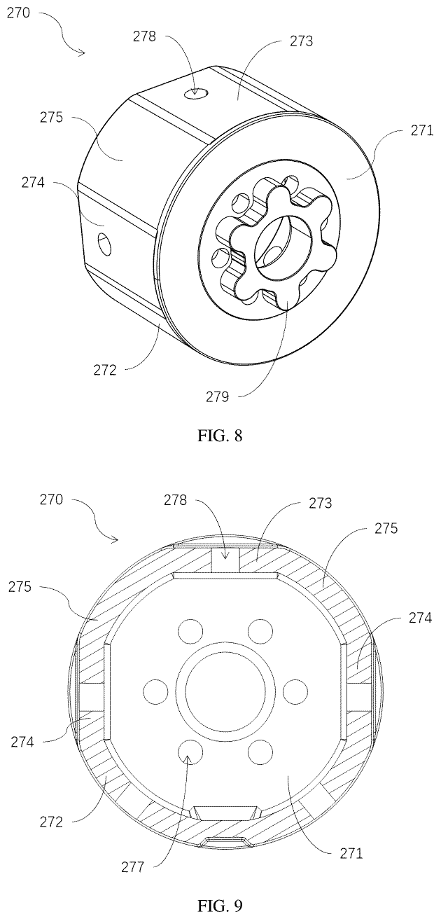

Embodiment 5. Based on the embodiment 4, as shown in FIG. 1, this embodiment also includes connecting parts 270 for connecting the photovoltaic main shaft. As shown in FIG. 8, the connecting member 270 includes an end portion 271 and a shaft head used to engage the photovoltaic main shaft. As shown in FIG. 9, the end portion 271 is plate-shaped and is provided with third mounting holes 277 that matches the first mounting holes 265 of the sixth transmission member 260. The connecting part 270 is detachably fixed to the sixth transmission member 260 using the first mounting holes 265 and the third mounting holes 277 to form a transmission connection.

As shown in FIG. 9, the cross-sectional outer contour of the shaft head is in the shape of a polygon of arcs and lines, and is used to engage a photovoltaic main shaft which also has a cross-sectional inner contour in a polygon of arcs and lines. The shaft head specifically includes a first arc plate 272 located below, a horizontal plate 273 located above, two vertical plates 274 located on both sides, and two second arc plates located between the horizontal plate 273 and the two vertical plates 274. The horizontal plate 273 and the vertical plate 274 are each provided with a second mounting hole 278. The first arc plate 272 is provided with two second mounting holes 278. The outer peripheries of the first arc plate 272 and the two second arc plates 275 are located on the same cylindrical surface. And after the connecting parts 270 are installed on the sixth transmission member 260, the cylindrical surface is coaxial with the sixth transmission member 260. Since the connecting parts 270 rotate together with the photovoltaic main shaft during actual operation, the orientation describing words such as “below”, “above”, “horizontal”, “vertical”, and “both sides” in this embodiment are all referring to the posture of the connecting part 270 when the connecting part 270 is at the middle position in the rotation range of the photovoltaic main shaft. This posture and similar postures correspond to the postures in which the photovoltaic main shaft is located during most of the working time.

Compared with the common square shaft head, D-shaped shaft head and other structures in the prior arts, the shaft head structure of the present application having a contour in a polygon of arcs and lines. Due to the arrangement of the vertical plates 274 and the first arc plate 272 below, the connecting parts 270 can withstand higher bending moments in the up and down direction. At the same time, with the same weight, the polygon in arcs and lines has a longer contour circumference than the square and D-shape, so it can achieve a higher torsional stiffness inertia, thereby transmitting higher torques. The shaft head with a contour in polygon of arcs and lines needs only 5 second mounting holes 278 to connect to the photovoltaic main shaft. Compared with the common 8 mounting holes for square shaft heads (2 on each side) and the common 7 mounting holes for D-shaped shaft heads (5 in the curved side and 2 in the straight side), the number of mounting holes is reduced.

In addition, as shown in FIG. 8, the end portion 271 may include a guiding protrusion 279. The guiding protrusion 279 is located on the end surface away from the shaft head, and its outer contour is matched with the opening on the first end plate 263 of the sixth transmission member 260. At the installation of the connecting parts 270, the guiding protrusion 279 not only facilitates the installation by the operator, but also allows the operator to easily adjust the orientation of the first arc plate 272 of the connecting parts 270 to align with the orientation of the worm gear portion 262 of the sixth transmission member 260. More preferably, referring to FIG. 7, one of the petal-shaped openings 266 can be reduced, or one of the petal-shaped openings 266 can be set smaller, and one of the radial protruding structures of the guiding protrusion 279 can be matched accordingly, so that the connecting member 270 and the sixth transmission member 260 can only be installed at a correct relative circumferential angle, thereby improving the installation efficiency.

The above are only the preferred embodiments of the present application and the technical principles used therein. Various obvious changes, readjustments and substitutions can be made without departing from the concept of the present application. Those skilled in the art can easily understand other advantages and effects of the present application from the content disclosed in this specification. This application can also be implemented or applied through other different specific embodiments, and various details in this specification can also be modified or changed in various ways based on different viewpoints and applications without departing from the spirit of this application. The above embodiments and features in the embodiments may be combined with each other as long as there is no conflict.

1. A transmission shaft mounting structure, characterized by comprising:
a housing provided with a first chamber;
a first transmission shaft, wherein a first end of the first transmission shaft is located inside the first chamber;
a first bearing and a second bearing, wherein the first transmission shaft is rotatably mounted to the housing through the first bearing and the second bearing;
a bushing that is installed between the first bearing and the second bearing so that the first bearing and the second bearing are axially spaced apart in the housing.

2. The transmission shaft mounting structure as claimed in claim 1, characterized in that,
the first transmission shaft is provided with an oil seal sleeve, wherein the oil seal sleeve is located between the first bearing and the second bearing, and
an inner wall of the oil seal sleeve is in sealing contact with the first transmission shaft, and
the transmission shaft mounting structure further comprises an oil seal, and the oil seal abuts against an outer wall of the oil seal sleeve.

3. The transmission shaft mounting structure as claimed in claim 1, characterized in that,
a transmission shaft mounting hole is provided at a chamber wall of the first chamber, and the first transmission shaft passes through the transmission shaft mounting hole into the first chamber; and a second end of the first transmission shaft is located outside the first chamber, wherein the first end and the second end are both used to install transmission members.

4. The transmission shaft mounting structure as claimed in claim 3, characterized in that,
one end of the transmission shaft mounting hole at the side of the first chamber has a radially inwardly protruding step structure, and an outer ring of the second bearing abuts against the step structure, and two sides of the bushing abut against an outer ring of the first bearing and the outer ring of the second bearing respectively; and
the transmission shaft mounting structure further comprises an adjustment plug, which is threadedly connected to the transmission shaft mounting hole and abuts against the outer ring of the first bearing at the side away from the first chamber.

5. A parallel driving device, characterized by comprising:
the transmission shaft mounting structure as claimed in claim 1;
a first transmission member that is fixedly connected to the first end of the first transmission shaft;
a second transmission member that is meshed with the first transmission member, wherein an axis of the first transmission member is perpendicular to an axis of the second transmission member;
a third transmission member that is fixedly connected to the second end of the first transmission shaft;
a fourth transmission member that is located on an upper side of the third transmission member and meshes with the third transmission member, wherein an axis of the fourth transmission member is parallel to an axis of the third transmission member;
a fifth transmission member that is coaxially fixed with the fourth transmission member;
a sixth transmission member which is located on an upper side of the fifth transmission member and meshes with the fifth transmission member, and an axis of the fifth transmission member is perpendicular to an axis of the sixth transmission member;
wherein, the sixth transmission member is above the second transmission member, and the axis of the sixth transmission member and the axis of the second transmission member are parallel to each other; wherein the first transmission member and the second transmission member are located inside the first chamber.

6. The parallel driving device as claimed in claim 5, characterized in that,
the housing is further provided with a second chamber and a third chamber; wherein
the third transmission member and the fourth transmission member are located in the second chamber, and
the second chamber is located on one side of the first chamber, and
the fifth transmission member and the sixth transmission member are located in the third chamber, and
the third chamber is located above the first chamber, and chamber walls of the first chamber, the second chamber and the third chamber are provided with a grease injection port respectively.

7. The parallel driving device as claimed in claim 5, wherein the sixth transmission member is a sector worm gear shaft, and the sixth transmission member comprises:
a main body that is in a shape of a round tube;
a worm gear portion that is circumferentially provided on the outer periphery of the main body;
a first end plate that is fixedly connected to a first end of the main body;
a second end plate that is fixedly connected to a second end of the main body;
wherein, the first end plate and the second end plate are both circumferentially provided with first mounting holes, and are both provided with an opening at a center position; and the fifth transmission member is a toroidal worm; and the toroidal worm is meshed with the worm gear portion in transmission.

8. The parallel driving device as claimed in claim 7, characterized in that,
the opening comprises a plurality of petal-shaped openings distributed circumferentially, and the first mounting holes are arranged between the petal-shaped openings.

9. The parallel driving device as claimed in claim 7, further comprising a connecting part, wherein,
the connecting part comprises an end portion and a shaft head, wherein the end portion is detachably fixed to the sixth transmission member using the first mounting holes, and
the cross-sectional outer contour of the shaft head is a polygon of arcs and lines, and
the shaft head is used to engage a photovoltaic main shaft with a cross-sectional inner contour as a polygon of arcs and lines; and
the shaft head comprises a first arc plate located below, a horizontal plate located above, two vertical plates located on two sides respectively, and two second arc plates located between the horizontal plate and the two vertical plates respectively; wherein the first arc plate, the horizontal plate and the vertical plate are provided with at least one second installation hole respectively; and
the outer peripheries of the first arc plate and the two second arc plates are located on a same cylindrical surface, and the cylindrical surface is coaxial with the sixth transmission member.

10. The parallel driving device as claimed in claim 9, characterized in that,
the end portion comprises a guiding protrusion that protrudes in a direction away from the shaft head, and the outer contour of the guiding protrusion matches the inner contour of the opening.

11. The parallel driving device as claimed in claim 5, characterized in that,
both the first transmission member and the second transmission member are helical gears.

12. The transmission shaft mounting structure as claimed in claim 1, characterized in that,
a first transmission member and a second transmission member are provided in the first chamber, wherein the first transmission member is fixedly connected to the first end of the first transmission shaft, and the second transmission member meshes with the first transmission member; and
a third transmission member and a fourth transmission member are provided in the housing, wherein the third transmission member is fixedly connected to the second end of the first transmission shaft and meshes with the fourth transmission member; and
a fifth transmission member and a sixth transmission member are provided in the housing and meshes with each other; and
wherein an axis of the fourth transmission member is parallel to an axis of the third transmission member, and the fifth transmission member is coaxially fixed with the fourth transmission member, and the sixth transmission member is located on an upper side of the fifth transmission member, and an axis of the fifth transmission member is perpendicular to an axis of the sixth transmission member, and the sixth transmission member is above the second transmission member, and the axis of the sixth transmission member and an axis of the second transmission member are parallel to each other.

13. The transmission shaft mounting structure as claimed in claim 12, characterized in that,
the housing further comprises a second chamber and a third chamber; and
the third transmission member and the fourth transmission member are provided in the second chamber and the fifth transmission member and the sixth transmission member are provided in the third chamber.

14. The transmission shaft mounting structure as claimed in claim 13, characterized in that,
the first chamber, the second chamber, and the third chamber are each provided with a grease injection port, and constitute three independent grease lubricated chambers in the housing.

15. The transmission shaft mounting structure as claimed in 13, characterized in that,
the second chamber is located on one side of the first chamber, and the third chamber is located above the first chamber,

[symbol]

16. The transmission shaft mounting structure as claimed in 13, characterized in that,
the fifth transmission member and the fourth transmission member are coaxially connected through a second transmission shaft which is rotatably installed in the housing through bearings provided on both sides of the third chamber; and
the second transmission member is fixedly connected to a third transmission shaft which is configured in a lower position in the first chamber through bearings.

17. The transmission shaft mounting structure as claimed in 16, characterized in that,
the third transmission shaft connects the second transmission member to a driving device.

18. The parallel driving device as claimed in claim 5, characterized in that,
the first transmission shaft is provided with an oil seal sleeve, wherein the oil seal sleeve is located between the first bearing and the second bearing, and
an inner wall of the oil seal sleeve is in sealing contact with the first transmission shaft, and
the transmission shaft mounting structure further comprises an oil seal, and the oil seal abuts against an outer wall of the oil seal sleeve.

19. The parallel driving device as claimed in claim 5, characterized in that,
a transmission shaft mounting hole is provided at a chamber wall of the first chamber, and the first transmission shaft passes through the transmission shaft mounting hole into the first chamber; and a second end of the first transmission shaft is located outside the first chamber, wherein the first end and the second end are both used to install transmission members.

20. The parallel driving device as claimed in claim 19, characterized in that,
one end of the transmission shaft mounting hole at the side of the first chamber has a radially inwardly protruding step structure, and an outer ring of the second bearing abuts against the step structure, and two sides of the bushing abut against an outer ring of the first bearing and the outer ring of the second bearing respectively; and
the transmission shaft mounting structure further comprises an adjustment plug, which is threadedly connected to the transmission shaft mounting hole and abuts against the outer ring of the first bearing at the side away from the first chamber.
